(19) United States
(12) Patent Application Publication
(10) Pub. No.: US 2025/0131800 A1
(43) Pub. Date: Apr. 24, 2025

(54) GUIDE SYSTEM, MANAGEMENT DEVICE, AND METHOD FOR CONTROLLING MANAGEMENT DEVICE

(71) Applicant: TOSHIBA TEC KABUSHIKI KAISHA, Tokyo (JP)

(72) Inventor: Naotake Hiramatsu, Ota Tokyo (JP)

(21) Appl. No.: 18/660,258

(22) Filed: May 10, 2024

(30) Foreign Application Priority Data
Oct. 19, 2023 (JP) 2023-180323

(51) Int. Cl. G07G 1/01; G06Q 20/20

(52) U.S. Cl. CPC G07G 1/01; G06Q 20/202

(57) ABSTRACT

It is made possible to introduce appropriate checkout apparatuses to customers who use a payment place where a plurality of checkout apparatuses different in class in which the checkout apparatus can perform a settlement is installed. A guide system includes first checkout apparatuses, at least one second checkout apparatus, an introduction device, and a management device. The first checkout apparatuses can accept settlements with first and second settlement methods. The second checkout apparatus can accept a settlement with the second settlement method. The introduction device introduces an available checkout apparatus. The management device determines the first checkout apparatus available for the first settlement method and the first and second checkout apparatuses available for the second settlement method based on unoccupied statuses of the first and second checkout apparatuses and a priority order set in advance, and makes the introduction device introduce the result.

### CROSS-REFERENCE TO RELATED APPLICATION

This application is based upon and claims the benefit of priority from Japanese Patent Application No. 2023-180323, filed on Oct. 19, 2023, the entire contents of which are incorporated herein by reference.

### FIELD

An embodiment of the present disclosure relates to a guide system, a management device, and a method for controlling a management device.

### BACKGROUND

In recent years, in mass retailers such as a supermarket, an introduction of a self-service checkout apparatus in which a customer him- or herself as a shopper performs checkout processing is in progress. Therefore, in such self-service checkout apparatuses, there are proposed a variety of techniques for leading and guiding the customer who performs the checkout processing to an unoccupied checkout apparatus.

Meanwhile, due to an increase in cashless settlement rate in recent years, an installation of a cashless settlement self-service checkout apparatus is increasing.

However, when the cashless settlement self-service checkout apparatus and the self-service checkout apparatus in which a cash settlement can also be used are included in an installation layout of the same payment place, personnel for managing and leading the customers in accordance with the settlement methods which the customers are going to use become necessary, and there is a problem that a gross profit per man-hour of a store degrades.

When it is unachievable to arrange such personnel, it is necessary to adopt a separate payment place layout in which the cashless settlement self-service checkout apparatus and the self-service checkout apparatus available for the cash settlement are separated from each other. When adopting such a separate layout, it is unachievable to effectively use the apparatuses in accordance with ever-changing utilization rates of the respective checkout apparatuses, and thus, the return on investment (ROI) tends to degrade.

### DESCRIPTION OF THE DRAWINGS

FIG. 1 is a schematic configuration diagram showing a guide system according to a first embodiment.

FIG. 2 is a schematic diagram showing an example of a payment place to which the guide system is applied.

FIG. 3 is a block diagram showing a circuit configuration of an essential part of a store server as a management device according to the first embodiment included in the guide system.

FIG. 4 is a schematic diagram showing a principal data structure to be stored in a guide configuration table provided to the store server.

FIG. 5 is a schematic diagram showing a principal data structure to be stored in a terminal status table provided to the store server.

FIG. 6 is a block diagram showing a circuit configuration of an essential part of a self-service terminal included in the guide system.

FIG. 7 is a schematic diagram showing an example of a camera-shot image which is obtained by a camera provided to the self-service terminal.

FIG. 8 is a schematic diagram similarly showing an example of the camera-shot image.

FIG. 9 is a schematic diagram similarly showing an example of the camera-shot image.

FIG. 10 is a sequence chart showing an operation outline related to an introduction of an unoccupied cash register in the guide system.

FIG. 11 is a flowchart representing a procedure of an essential part of information processing to be executed by a processor of the store server.

FIG. 12 is a schematic diagram showing a principal data structure to be stored in the terminal status table provided to the store server.

FIG. 13 is a diagram showing a display example of a first display surface in a display device included in the guide system.

FIG. 14 is a diagram similarly showing a display example of a second display surface in the same display device.

FIG. 15 is a schematic diagram showing an example of a payment place to which a guide system according to a second embodiment is applied.

FIG. 16 is a diagram showing a display example of first and display surfaces in a display device included in the guide system.

FIG. 17 is a schematic diagram showing a principal data structure to be stored in the guide configuration table provided to the store server.

### DETAILED DESCRIPTION

A problem to be solved by the embodiments of the present disclosure is to provide a guide system, a management device, and a method for controlling the management device which make it possible to introduce appropriate checkout apparatuses to the customers who use the payment place where a plurality of checkout apparatuses different in class in which the checkout apparatus can achieve a settlement is installed.

In one embodiment, a guide system includes a plurality of first checkout apparatuses, at least one second checkout apparatus, an introduction device, and a management device. The first checkout apparatuses are checkout apparatuses configured to accept settlements with a first settlement method and a second settlement method. The second checkout apparatus is a checkout apparatus configured to accept a settlement with the second settlement method. The introduction device introduces an available checkout apparatus. The management device determines the first checkout apparatus available for the first settlement method and the first and second checkout apparatuses available for the second settlement method based on unoccupied statuses of the first and second checkout apparatuses and a priority order set in advance, and makes the introduction device introduce the result.

Some embodiments of a checkout apparatus will hereinafter be described using the drawings.

### First Embodiment

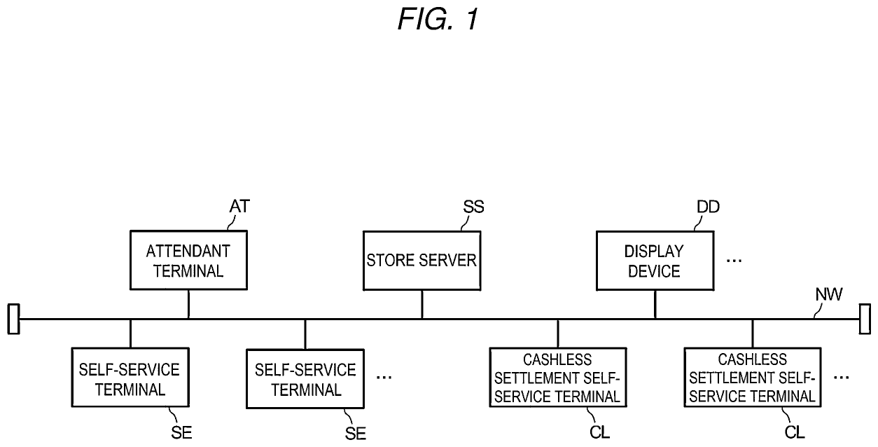

FIG. 1 is a schematic configuration diagram showing a guide system according to a first embodiment. The guide system according to the first embodiment is applied to a checkout system of a self-service type. The checkout system includes a store server SS as a management device according to the first embodiment, a plurality of checkout apparatuses, and an attendant terminal AT, and is configured by connecting the checkout apparatuses, the store server SS, and the attendant terminal AT to each other with a communication network NW such as a local area network (LAN). As the checkout apparatuses, there exist a self-service terminal SE and a cashless settlement self-service terminal CL. The self-service terminal SE is an example of a self-service checkout apparatus available for the cash settlement. The cashless settlement self-service terminal CL is an example of a cashless settlement self-service checkout apparatus. The guide system is configured by connecting one or more display device DD to the communication network NW in such a checkout system.

The store server SS provides a variety of services related to the checkout system to the checkout apparatuses connected with the communication network NW. Further, the store server SS transmits display information representing contents to be displayed on the display device DD to each of the display devices DD connected with the communication network NW.

In the present embodiment, the checkout system includes a plurality of self-service terminals SE and one or more cashless settlement self-service terminal CL as the checkout apparatuses. The self-service terminals SE are each a checkout apparatus having a checkout function available for both of cash payment and cashless payment in which cash is not used. The self-service terminal SE is an example of a first checkout apparatus which is capable of accepting the cash settlement as a first settlement method and the cashless settlement as a second settlement method. The cashless settlement includes a credit card settlement, an electronic money settlement, a point settlement, a code settlement, and so on. Further, the cashless settlement self-service terminal CL is a checkout apparatus having the checkout function available for cashless payment in which cash is not used. The cashless self-service terminal CL is an example of a second checkout apparatus which is capable of accepting the cashless settlement as the second settlement method. The cashless settlement includes a credit card settlement, an electronic money settlement, a point settlement, a code settlement, and so on.

These self-service terminals SE and cashless settlement self-service terminals CL are installed in a payment place as a checkout area of a store, and shoppers as customers who complete shopping act as operators. The customer who puts the purchased article in a shopping basket or loads a shopping cart with the purchased article in a salesroom where articles are displayed, and then moves to the payment place, operates the self-service terminal SE or the cashless settlement self-service terminal CL to perform registration processing of the purchased article and checkout processing, namely payment, on transaction data of the purchased article the article registration of which is completed. As described above, the shoppers perform the settlement related to the transaction from the article registration to the payment by him- or herself.

Further, the self-service terminal SE or the cashless settlement self-service terminal CL is not necessarily required to have a function of registering the purchased article. In this case, the shopper performs the article registration of the article to be purchased by the shopper him- or herself using a tablet terminal attached to a shopping cart or the like, a portable terminal owned by the shopper, or the like in advance during shopping in the salesroom of the store. Further, the self-service terminal SE which does not have the function of registering the purchased article executes the checkout processing on the transaction data of the purchased article the article registration of which is performed by the shopper him- or herself with either of the cash payment method and the cashless payment method. Further, the cashless settlement self-service terminal CL which does not have the function of registering the purchased article executes the checkout processing on the transaction data of the purchased article the article registration of which is performed by the shopper him- or herself with the cashless payment method.

It should be noted that the checkout apparatus can be reworded as a settlement terminal, a payment device, a payment terminal, and so on. Further, an ordinary POS terminal having an article registration function and a settlement function may be applied as the checkout apparatus in the present checkout system.

The attendant terminal AT is a terminal which is operated by a sales clerk as an attendant. The attendant terminal AT displays a list of the purchased articles which are registered in each of the checkout apparatuses or the like on a display device. Further, when an error occurs in any of the checkout apparatuses, the attendant terminal AT announces information of that error. The attendant monitors the checkout apparatuses based on the information displayed in the attendant terminal AT, or the information thus announced. Further, the attendant terminal AT may be provided with a function as the checkout apparatus to be operated by the attendant. In the attendant terminal AT, it is possible to perform the cash settlement and the cashless settlement, and at the same time, to deal with settlements which require a manual operation such as a settlement with a cash voucher or a gift voucher which are not machine-readable, returning of an article, and refund.

The display device DD is a display device such as a liquid crystal display. The display device DD displays display information which is transmitted from the store server SS, and which is for performing display for introducing a device which is available at the present moment in the checkout apparatuses included in the checkout system to the shoppers who are going to check out. The display device DD is an example of an introduction device for introducing the available checkout apparatus. Therefore, the introduction device can be rephrased as displaying the display information for performing display for introducing the available checkout apparatus. It can be said that the introduction device performs the display showing an unoccupied cash register (a device which is not used, namely an unoccupied device) corresponding to the settlement method.

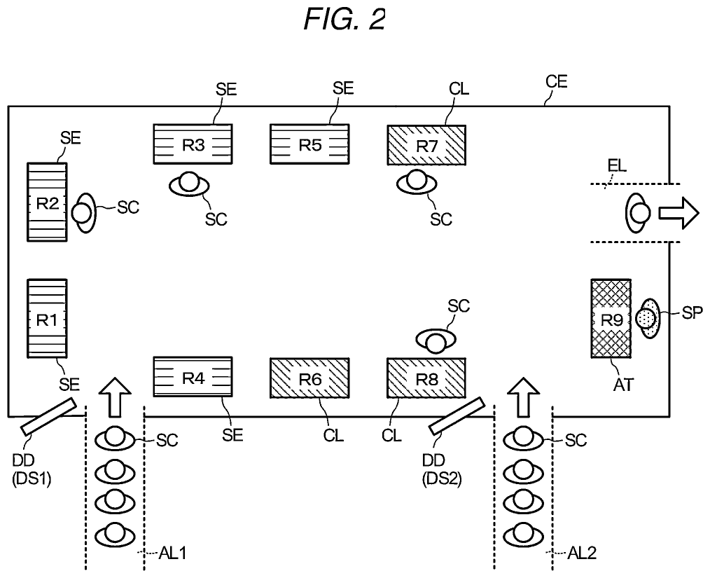

FIG. 2 is a schematic diagram showing an example of a payment place CE to which the guide system is applied. In the example in FIG. 2, five self-service terminals SE, three cashless settlement self-service terminals CL, and one attendant terminal AT are installed as the checkout apparatuses in the payment place CE. Although not limited thereto, the configuration and the operation are hereinafter described based on the number and the installation layout of the checkout apparatuses in the payment place CE.

In the payment place CE, an entrance for cash payment shoppers and an entrance for cashless payment shoppers are set separately from each other, and exits thereof are set commonly to the both shoppers. In the entrance for the cash payment shoppers, a first entrance lane AL1 in which the cash payment shoppers SC stand for checkout is disposed. The first entrance lane AL1 is an example of a first standby lane for the first settlement method. Further, in the entrance for the cashless payment shoppers, a second entrance lane AL2 in which the cashless payment shoppers SC stand for checkout is disposed. The second entrance lane AL2 is an example of a second standby lane for the second settlement method. In the exit, an exit lane EL passed by the shoppers SC who complete the checkout is disposed.

Further, in the payment place CE, one display device DD is installed so as to correspond to the first entrance lane AL1, and another display device DD is installed so as to correspond to the second entrance lane AL2. It can also be said that the display devices DD are arranged one by one in the entrance of the cash payment shoppers and the entrance of the cashless payment shoppers. In other words, FIG. 2 shows an example when the display devices DD are each the introduction device which introduces the available checkout apparatus to the customer.

It should be noted that cash register numbers R1 through R9 for uniquely identifying the respective checkout apparatuses are assigned to nine checkout apparatuses including the self-service terminals SE and the cashless settlement self-service terminals CL. The cash register numbers R1 through R9 can be assigned as appropriate by an administrator of the store server SS.

A sales clerk SP is assigned to the attendant terminal AT.

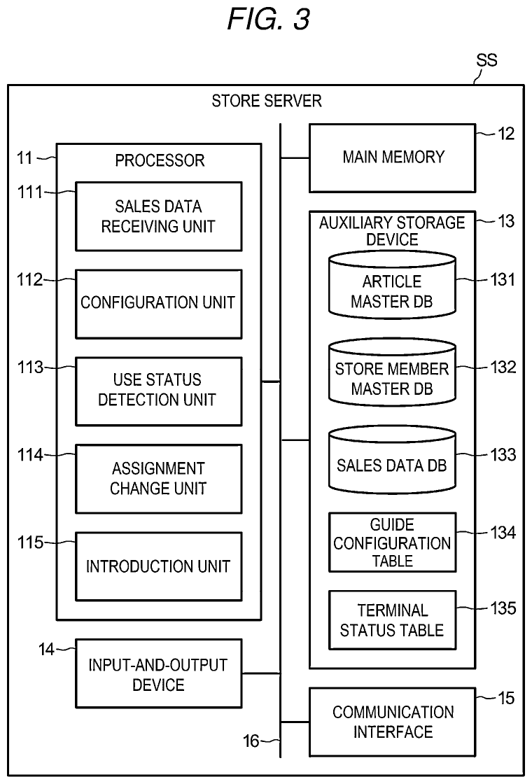

FIG. 3 is a block diagram showing a circuit configuration of an essential part of the store server SS. The store server SS is provided with a processor 11, a main memory 12, an auxiliary storage device 13, an input-and-output device 14, a communication interface 15, and a system transmission path 16. The system transmission path 16 includes an address bus, a data bus, control signal lines, and so on. The system transmission path 16 couples the processor 11 and other units to each other directly, or via a signal input-and-output circuit, and transmits data signals which are mutually received or transmitted therebetween. The processor 11, the main memory 12 and the auxiliary storage device 13 are coupled to each other with the system transmission path 16 to thereby configure a computer of the store server SS.

The processor 11 corresponds to a central portion of the computer described above. The processor 11 controls each unit so as to realize a variety of types of functions as the store server SS with an operating system or a control program. The processor 11 is, for example, a central processing unit (CPU). The processor 11 can also be, for example, a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 11 can be what is obtained by combining some of these with each other.

The main memory 12 corresponds to a main storage portion of the computer described above. The main memory 12 includes a nonvolatile memory area and a volatile memory area. The main memory 12 stores the operating system or the control program in the nonvolatile memory area. The main memory 12 stores data which is necessary for the processor 11 to execute processing for controlling each unit in the nonvolatile memory area or the volatile memory area in some cases. The main memory 12 uses the volatile memory area as a work area in which data is rewritten as appropriate by the processor 11. The nonvolatile memory area is, for example, a read only memory (ROM). The volatile memory area is, for example, a random access memory (RAM).

The auxiliary storage device 13 corresponds to an auxiliary storage portion of the computer described above. For example, an electrically erasable programmable read-only memory (EEPROM), a hard disc drive (HDD), or a solid state drive (SSD) may be the auxiliary storage device 13. The auxiliary storage device 13 stores data which is used by the processor 11 when performing a variety of types of processing, data which is generated by the processing in the processor 11, and so on. The auxiliary storage device 13 stores the control program described above in some cases.

The input-and-output device 14 is a user interface including input equipment such as a keyboard or a mouse, and display equipment such as a liquid crystal display. It should be noted that the store server SS is not necessarily required to have the input-and-output device 14. As the user interface on this occasion, it is possible to use a management terminal not shown which is capable of making communication via a communication network NW using the communication interface 15. The management terminal may include, for example, a personal computer, a smartphone, or a tablet computer.

The communication interface 15 performs data communication in compliance with a communication protocol set in advance with an external device which is connected via the communication network NW. The external device is, for example, the self-service terminal SE, the cashless settlement self-service terminal CL, the attendant terminal AT, the display device DD, or the like.

The store server SS is provided with an article master database 131, a store member master database 132, a sales data database 133, a guide configuration table 134, and a terminal status table 135 in the auxiliary storage device 13. In FIG. 3, a database is abbreviated as DB.

The article master database 131 stores data related to articles to be sold in the store. The article master database 131 stores data such as an article ID, an article name, a price, and a class name taking one article as one record. The article ID is a unique code set for each article in order to individually identify the article.

The store member master database 132 stores data related to customers who registered as members such as point members, namely so-called affiliates. The store member master database 132 includes data of, for example, a member ID taking one member as one record. Personal information such as gender, age, name, address, and contact of the member may be included. The member ID is a unique code set for each member in order to individually identify the member. The member owns a recording medium on which the member ID is recorded. The recording medium is, for example, a magnetic card, a contact integrated circuit (IC) card, a noncontact IC card, or a smartphone. The purchaser can appreciate a benefit as the member by inputting the member code into the checkout apparatus at any timing before making payment, namely settlement, on the checkout apparatus. Regarding an input method of the member code, reading from the medium by the shopper SC with a scanner or a reader provided to the checkout apparatus and so on are available, and the input method is not particularly limited.

The sales data database 133 stores the sales data generated in the transactions which is transmitted from each of the checkout apparatuses when the settlement is completed, namely when the transaction is completed. The sales data database 133 stores transaction data representing a transaction content of an article as a settlement target, and settlement data related to the settlement of that transaction taking one transaction as one record. The transaction data includes an article name (article code) and a price of the article subjected to the settlement, a total amount of the articles, and so on. The settlement data includes a deposit amount paid by the purchaser, an amount of change, and so on when the payment was made in cash, or includes information of the payment method when cashless payment was made. Further, the sales data may include elements such as a member code, a corporate code (corporate name) representing a company which operates the store, a store code (store name), a phone number of the store, an address thereof, transaction time and date, a transaction number (receipt number), a cash register number, and a name of the person in charge. It should be noted that the elements included in the sales data are not limited to these examples, and may include other elements, and elements such as the phone number and the address may also be eliminated. In the checkout apparatus, for example, by reading a code symbol printed on or attached to an article with a scanner to obtain the article code, and then reading article data of the article identified by the article code from an article data file provided to the checkout apparatus, and then registering the article data in the transaction data, the sales data including the transaction data and the settlement data is updated and then stored. The article data file may be a copy of the article master database 131. Further, when the member code is obtained from the recording medium with the scanner, the checkout apparatus confirms whether the member code is registered in a store member data file provided to the checkout apparatus, and when the member code is registered, the checkout apparatus adds the member code to the transaction data as the store member code to thereby update and then store the sales data. When the settlement process is completed, namely when one transaction is completed, the checkout apparatus prints the sales data on a sheet to thereby issue a paper receipt corresponding to one transaction, and at the same time, transmits the sales data corresponding to the one transaction to the store server SS. The sales data database 133 stores the sales data transmitted from each of the checkout apparatuses in such a manner.

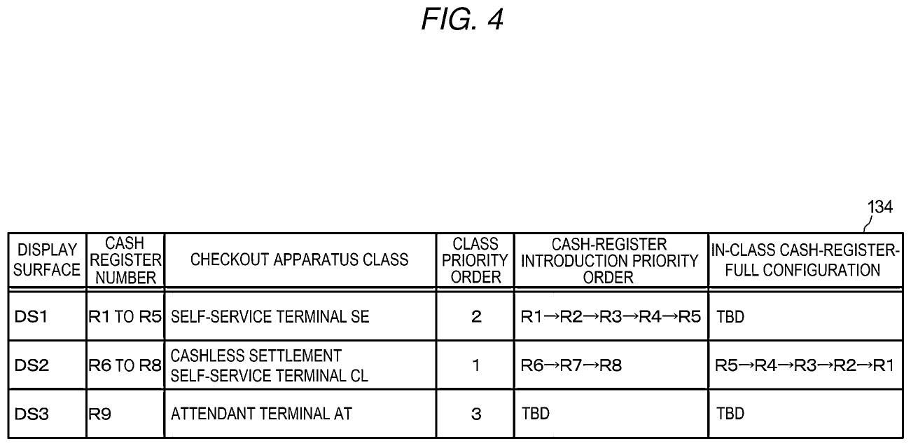

The guide configuration table 134 stores a variety of configurations related to an introductory display of an unoccupied cash register input in advance by the administrator. FIG. 4 is a schematic diagram showing a principal data structure to be stored in this guide configuration table 134. It should be noted that the data structure shown in FIG. 4 is an example. As long as the information necessary for the processor 11 can be obtained, the format is not particularly limited.

As shown in FIG. 4, the guide configuration table 134 stores a display surface, the cash register number, a class priority order, a cash-register introduction priority order, and an in-class cash-register-full configuration, for example, for each checkout apparatus class. The checkout apparatus class represents the class of the checkout apparatus. In the example in FIG. 4, the checkout apparatus classes include the self-service terminal SE, the cashless settlement self-service terminal CL, and the attendant terminal AT.

The display surface means an introductory display surface of the display device DD for introducing an unoccupied cash register to the shoppers in the payment place CE. Display surfaces DS1 through DS3 shown in FIG. 4 are each identification information for identifying the display surface of the display device DD in the present embodiment. The display device DD and the display surface may have a one-to-one relationship, or one display device DD may also be associated with two or more display surfaces assuming that there is adopted a display method in which a display screen is divided into a plurality of parts to achieve a split screen. In the present embodiment, the display device DD and the introductory display surface have a one-to-one relationship. Therefore, the display surface may be reworded as the display device. In the example in FIG. 4, the display device DD installed so as to correspond to the first entrance lane AL1 in which the cash payment shoppers SC stand for checkout is set as a first display surface DS1, and the display device DD installed so as to correspond to the second entrance lane AL2 in which the cashless payment shoppers SC stand for checkout is set as a second display surface DS2.

It should be noted that although the three display surfaces DS1 through DS3 are set in FIG. 4, since the number of the display devices DD installed in the payment place CE is two as shown in FIG. 2, the processor 11 ignores the configuration regarding the display surface DS3. Obviously, it is possible to add one more display device DD to apply the configuration regarding the display surface DS3 to the display device DD thus added.

The cash register number is an identifier assigned to the checkout apparatus in each of the checkout apparatus classes. The example in FIG. 4 corresponds to an installation layout of the payment place CE as shown in FIG. 2. Specifically, the cash register numbers of the self-service terminals SE are R1 through R5, the cash register numbers of the cashless settlement self-service terminals CL are R6 through R8, and the cash register number of the attendant terminal AT is R9.

The class priority order represents a priority order related to the classes of the checkout apparatuses. The class priority order is an example of a priority order of the settlement method. FIG. 4 shows when an order of the cashless settlement self-service terminal CL, the self-service terminal SE, and the attendant terminal AT is designated as the class priority order.

The cash-register introduction priority order represents a priority order of the checkout apparatus regarding which one of the checkout apparatuses is introduced first when there are two or more unoccupied cash registers. In the example in FIG. 4, an order of the cash register number R1, the cash register number R2, the cash register number R3, the cash register number R4, and the cash register number R5 is set as the cash-register introduction priority order in the self-service terminal SE. Further, in the cashless settlement self-service terminal CL, an order of the cash register number R6, the cash register number R7, and the cash register number R8 is set as the cash-register introduction priority order. It should be noted that regarding the attendant terminal AT, just one cash register is assigned, and therefore, the cash-register introduction priority order is left unset.

When the cash registers assigned for each of the checkout apparatus classes become full, and when the cash register assigned to another class is used as the cash register for that class, the in-class cash-register-full configuration represents an order of the cash registers to newly be assigned to that class. When the cash registers assigned for each of the checkout apparatus classes is full means in other words that there is no unoccupied cash register. In other words, all of the checkout apparatuses assigned are all in use. The in-class cash-register-full configuration is an example of a priority order when assigning the checkout apparatus which belongs to the settlement method in a lower priority order to a settlement method in a higher priority order. In the example in FIG. 4, an order of the cash register number R5, the cash register number R4, the cash register number R3, the cash register number R2, and the cash register number R1 as the numbers of the self-service terminals SE is set as the configuration when the cashless settlement self-service terminals CL which are the highest in the class priority order are full.

It should be noted that in the example in FIG. 4, the configuration when the self-service terminals SE in the subsequent priority order are full is left unset. This is because the cashless settlement self-service terminal CL cannot accept the cash payment, and therefore, the cashless settlement self-service terminal CL cannot become a substitute for the self-service terminal SE. Further, this is because a unit for registering an article provided to the attendant terminal AT is disposed at the sales clerk SP side, and is not arranged so as to be operated by the shopper SC although the cash payment is possible in the attendant terminal AT. Moreover, since the sales clerk SP assigned to the attendant terminal AT needs to give priority to an original task as the attendant, it is not desirable to use the cashless settlement self-service terminal CL as a substitute for the self-service terminal SE.

Further, in the example in FIG. 4, the configuration when the attendant terminal AT becomes full is also left unset. This is because the self-service terminal SE and the cashless settlement self-service terminal CL are not provided with the function of the attendant terminal AT, and cannot therefore become a substitute for the attendant terminal AT.

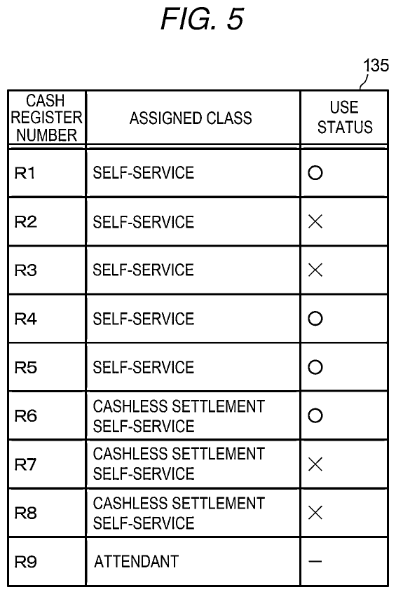

The terminal status table 135 stores a use status at the present moment with respect to each of the checkout apparatuses. FIG. 5 is a schematic diagram showing a principal data structure to be stored in this terminal status table 135. It should be noted that the data structure shown in FIG. 5 is illustrative only. As long as the information necessary for the processor 11 can be obtained, the format is not particularly limited.

As shown in FIG. 5, the terminal status table 135 stores an assignment class and the use status, for example, for each of the cash register numbers.

The assigned class represents that the cash register currently operates as what class of the checkout apparatus.

The use status represents whether that cash register is currently in use. In this use status, a round mark represents that the cash register is not in use, namely unoccupied, and an X mark represents that the cash register is in use. A hyphen represents an exemption. FIG. 5 shows a status of the payment place CE shown in FIG. 2. Specifically, an example of the terminal status table 135 in FIG. 5 represents the status that the self-service terminals SE with the cash register numbers R2 and R3 are in use, the self-service terminals SE with the cash register numbers R1, R4, and R5 are unoccupied, the cashless settlement self-service terminals CL with the cash register numbers R7 and R8 are in use, and the cashless settlement self-service terminal CL with the cash register number R6 is unoccupied.

Then, each unit to be installed in the processor 11 of the store server SS will be described. The processor 11 implements, for example, a sales data receiving unit 111, a configuration unit 112, a use status detection unit 113, an assignment change unit 114, and an introduction unit 115. The units installed in the processor 11 can also be referred to as functions. It can be said that the units installed in the processor 11 are installed in a control unit including the processor 11 and the main memory 12.

The sales data receiving unit 111 receives the sales data corresponding to one transaction which is transmitted from the checkout apparatus when the one transaction is completed with the communication interface 15. The sales data receiving unit 111 stores the transaction data thus received in the transaction data database 133.

The configuration unit 112 receives a variety of types of configuration information with respect to configuration items in the guide configuration table 134 due to an operation of the administrator of the store server SS using the input-and-output device 14. The configuration unit 112 stores the variety of types of configuration information thus received in the guide configuration table 134.

The use status detection unit 113 detects the use statuses of the self-service terminals SE and the cashless settlement self-service terminals CL. The use status detection unit 113 is an example of a detection unit for detecting an unoccupied status of each of the self-service terminals SE as the first checkout apparatuses and the cashless settlement self-service terminals CL as the second checkout apparatuses. For example, in the present embodiment, as described later, the self-service terminals SE and the cashless settlement self-service terminals CL are configured so as to transmit a human detection notice when there is a human in an operation range thereof. Therefore, the use status detection unit 113 can detect whether each of the checkout apparatuses is in use based on whether this human detection notice is received with the communication interface 15. The use status detection unit 113 stores the use status thus detected in the terminal status table 135.

The assignment change unit 114 changes the assigned class of each of the checkout apparatuses based on the use status of each of the checkout apparatuses stored in the terminal status table 135 and the variety of configurations related to the introductory display of the unoccupied cash register stored in the guide configuration table 134. The details of the change in assigned class will be described later. The assignment change unit 114 is an example of an assignment unit which determines the first checkout apparatus available for the first settlement method and first and second checkout apparatuses available for the second settlement method based on the unoccupied status of each of the first and second checkout apparatuses detected by the detection unit and the priority order set in advance. The assignment change unit 114 updates the assigned class of the terminal status table 135 with the assigned class thus changed.

The introduction unit 115 generates the display information for the introductory display to be displayed on the display surface of each of the classes set in the guide configuration table 134 in accordance with the assigned class stored in the terminal status table 135, and then transmits the display information to each of the display devices DD with the communication interface 15. The display information of the introductory display includes first introductory information representing the self-service terminals SE available for the cash payment use, and second introductory information which represents the cashless settlement self-service terminals CL available for the cashless payment use, and which represents the self-service terminals SE in some cases. A specific example of the display information for the introductory display will be described later. The introduction unit 115 is an example of an output unit which outputs the first introductory information which is determined by the assignment unit, and which represents the first checkout apparatus available for the first settlement method and the second introductory information which is determined by the assignment unit, and which represents the first and second checkout apparatuses available for the second settlement method to the display device DD as an external device.

It should be noted that the store server SS can be realized by, for example, using a general-purpose computer device for a server as hardware, and writing a control program into the main memory 12 or the auxiliary storage device 13. It should be noted that the control program may be stored in the main memory 12 or the auxiliary storage device 13 when delivering the store server SS, or may also be delivered separately from the general-purpose computer device described above. In the latter case, the control program is delivered as a removable recording medium such as a magnetic disc, a magnetooptic disc, an optical disc, or a semiconductor memory recording the control program, or is delivered via a network.

Then, a configuration of the checkout apparatus will be described.

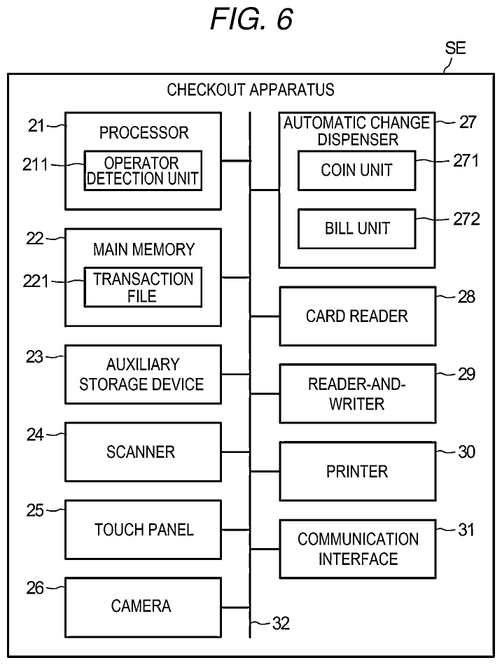

First, the self-service terminal SE will be described. FIG. 6 is a block diagram showing a circuit configuration of an essential part of the self-service terminal SE. The self-service terminal SE is provided with a processor 21, a main memory 22, an auxiliary storage device 23, a scanner 24, a touch panel 25, a camera 26, an automatic change dispenser 27, a card reader 28, a reader and writer 29, a printer 30, a communication interface 31, a system transmission path 32, and so on. The system transmission path 32 includes an address bus, a data bus, control signal lines, and so on. The system transmission path 32 couples the processor 21 and other units to each other directly, or via a signal input-and-output circuit, and transmits data signals which are mutually received or transmitted therebetween. The processor 21, the main memory 22 and the auxiliary storage device 23 are coupled to each other with the system transmission path 32 to thereby configure a computer of the self-service terminal SE.

The processor 21 corresponds to a central portion of the computer described above. The processor 21 controls each unit so as to realize a variety of types of functions as the self-service terminal SE with an operating system or a control program. The processor 21 is, for example, a CPU. The processor 21 may be, for example, an MPU, an SoC, a DSP, a GPU, and ASIC, a PLD, or an FPGA. Alternatively, the processor 21 can be what is obtained by combining some of these with each other.

The main memory 22 corresponds to a main storage portion of the computer described above. The main memory 22 includes a nonvolatile memory area and a volatile memory area. The main memory 22 stores the operating system or the control program in the nonvolatile memory area. The main memory 22 stores data which is necessary for the processor 21 to execute processing for controlling each unit in the nonvolatile memory area or the volatile memory area in some cases. For example, the main memory 22 stores a transaction file 221. The transaction file 221 is a data file for storing the sales data corresponding to one transaction processed by the self-service terminal SE. The main memory 22 uses the volatile memory area as a work area in which data is rewritten as appropriate by the processor 21. The nonvolatile memory area is, for example, a ROM. The volatile memory area is, for example, a RAM.

The auxiliary storage device 23 corresponds to an auxiliary storage portion of the computer described above. For example, an EEPROM, an HDD, or an SSD may be the auxiliary storage device 23. The auxiliary storage device 23 stores data which is used by the processor 21 when performing a variety of types of processing, data which is generated by the processing in the processor 21, and so on. For example, the auxiliary storage device 23 may store the article data file and the store member data file described above. The auxiliary storage device 23 stores the control program described above in some cases.

The scanner 24 reads the code symbol from the article. To each of the articles to be sold in a store, the code symbol obtained by coding an article ID or the like for identifying that article is attached. The code symbol is, for example, a barcode. The code symbol may be, for example, a two-dimensional data code. The scanner 24 may be of a type which reads the code symbol by scanning with a laser beam, or of a type which reads the code symbol from an image taken by an imaging device.

The touch panel 25 is configured by a display for displaying a variety of screens to the shopper SC who operate the self-service terminal SE, and a touch sensor for detecting touch input to the screen by the shopper SC.

The camera 26 sets a terminal operating range as an imaging area, in which the shopper SC is assumed to be located in the terminal operating range when the shopper SC performs operations such as an operation of taking out a purchased article from a shopping basket or a shopping cart to make the scanner 24 scan the barcode of the purchased article, and an operation of making a payment with cash or a credit card. Thus, it is possible for the camera 26 to shoot the shopper SC who operates that self-service terminal SE.

The automatic change dispenser 27 includes a coin unit 271 and a bill unit 272. The coin unit 271 sorts out coins dropped in a coin slot one by one to identify the denomination, and then houses the coins in a safe by denomination. The coin unit 271 takes out the coins of the corresponding denomination from the safe based on, for example, change data, and then pays them out to a coin dispensing port. The bill unit 272 sorts out bills inserted in a bill slot one by one to identify the denomination, and then houses the bills in the safe by denomination. The bill unit 272 takes out the bills of the corresponding denomination from the safe based on, for example, change data, and then pays them out to a bill dispensing port.

The card reader 28 reads card data recorded on a card medium such as a credit card or a reward card. The card reader 28 draws in the card medium inserted into a card slot inside the main body to read the card data, and then discharge the card medium from the card slot.

The reader-and-writer 29 performs reading and rewriting of electronic money recorded on an electronic money medium. The electronic money medium is, for example, a noncontact IC card. The electronic money medium may also be an electronic device such as a smartphone or a tablet terminal.

The printer 30 prints a receipt data representing a content of a business transaction or the like on a receipt form. The receipt form on which the receipt data is printed is discharged from an issue port, cut by a cutter, and then issued as a receipt or a voucher.

The communication interface 31 performs data communication in compliance with a communication protocol set in advance with an external device which is connected via the communication network NW. The external device is, for example, the store server SS, the attendant terminal AT, or the like.

The processor 21 implements, for example, an operator detection unit 211 in addition to a well-known processing unit related to the article registration and the settlement. The units installed in the processor 21 can also be referred to as functions. It can be said that the units installed in the processor 21 are installed in a control unit including the processor 21 and the main memory 12.

The operator detection unit 211 detects presence or absence of the shopper SC as the operator who operates that self-service terminal SE from the camera-shot images obtained by the camera 26 at regular time intervals. The operator detection unit 211 detects the presence or absence of a human using a human recognition technique such as a well-known face detection method.

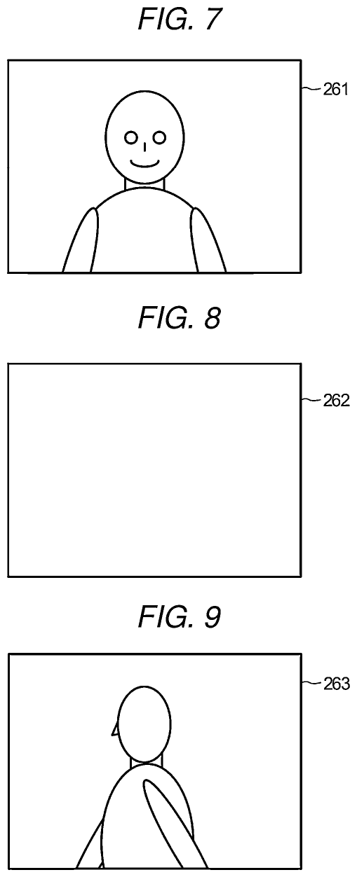

FIG. 7 is a schematic diagram showing an example of the camera-shot image 261. As shown in FIG. 7, when the camera-shot image 261 on which a human shows up is taken, the operator detection unit 211 transmits a human detection notice to the store server SS with the communication interface 31 when the operator detection unit 211 detects that a human is present. It is possible for the use status detection unit 113 of the store server SS to detect that the self-service terminal SE is in use based on this human detection notice as described above, to thereby store the status in the terminal status table 135.

FIG. 8 and FIG. 9 are each a schematic diagram similarly showing an example of the camera-shot image. The operator detection unit 211 cannot detect a human from the camera-shot image 262 on which no human shows up as shown in FIG. 8 and the camera-shot image 263 on which a human passing in front of the self-service terminal SE shows up as shown in FIG. 9. Therefore, in this case, the operator detection unit 211 does not transmit the human detection notice to the store server SS. Therefore, it is possible for the use status detection unit 113 of the store server SS to detect that the self-service terminal SE from which no human detection notice is transmitted is not in use, namely is in the unoccupied status, to thereby store the status in the terminal status table 135.

The cashless settlement self-service terminal CL does not handle cash, and is therefore not provided with the automatic change dispenser 27. The cashless settlement self-service terminal CL has substantially the same configuration as that of the self-service terminal SE except the fact that the automatic change dispenser 27 is absent.

The attendant terminal AT has substantially the same configuration as that of the self-service terminal SE shown in FIG. 6. It should be noted that in the attendant terminal AT, the statuses of each of the self-service terminals SE and each of the cashless settlement self-service terminals CL are stored in the main memory 22. For example, the attendant terminal AT is capable of storing a list of the purchased articles registered in each of the self-service terminals SE and each of the cashless settlement self-service terminals CL, error occurrence statuses thereof, and so on in the main memory 22. The attendant terminal AT displays the statuses of each of the self-service terminals SE and each of the cashless settlement self-service terminals CL stored in the main memory 22 on the display of the touch panel 25.

An operation of the guide system applied to the checkout system having such a configuration will hereinafter be described. It should be noted that an operation related to the checkout in the checkout system is the same as that in a well-known checkout system, and therefore, the description thereof will be omitted. Further, an operation related to setting to the guide configuration table 134 in the guide system is nothing but performing setting for each of the configuration items, and therefore, the description thereof will also be omitted. Therefore, an operation related to the introduction of the unoccupied cash register will be described here.

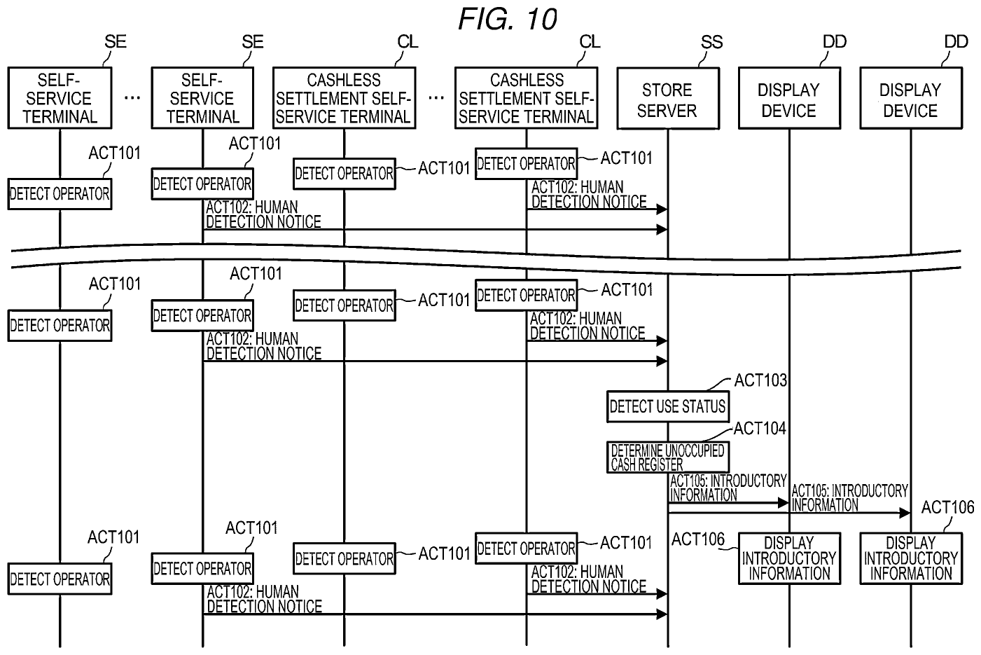

FIG. 10 is a sequence chart showing an operation outline related to the introduction of the unoccupied cash register in the guide system. As shown in FIG. 10, each of the self-service terminals SE and the cashless settlement self-service terminals CL, namely each of the checkout apparatuses, performs (ACT101) operator detection processing for detecting presence or absence of a shopper SC as an operator at regular time intervals. The checkout apparatus which detects the presence of a human transmits (ACT102) the human detection notice to the store server SS. It should be noted that the operator detection processing is not required to be synchronized between the checkout apparatuses, and is executed at regular time intervals of respective timings.

In the store server SS, the use status of each of the checkout apparatuses is detected (ACT103) based on the human detection notice transmitted from each of the checkout apparatuses at regular time intervals different from the regular time intervals in the checkout apparatuses. In the store server SS, an unoccupied cash register available for the cash payment and an unoccupied cash register available for the cashless payment are determined (ACT104) based on the unoccupied status of each of the checkout apparatuses and the priority order set in advance. Then, the store server SS transmits (ACT105) introductory information representing the unoccupied cash register thus determined to the display device DD.

The display device DD which receives the introductory information displays (ACT106) the introductory information.

The operation of the store server SS in ACT103 through ACT105 will hereinafter be described in detail.

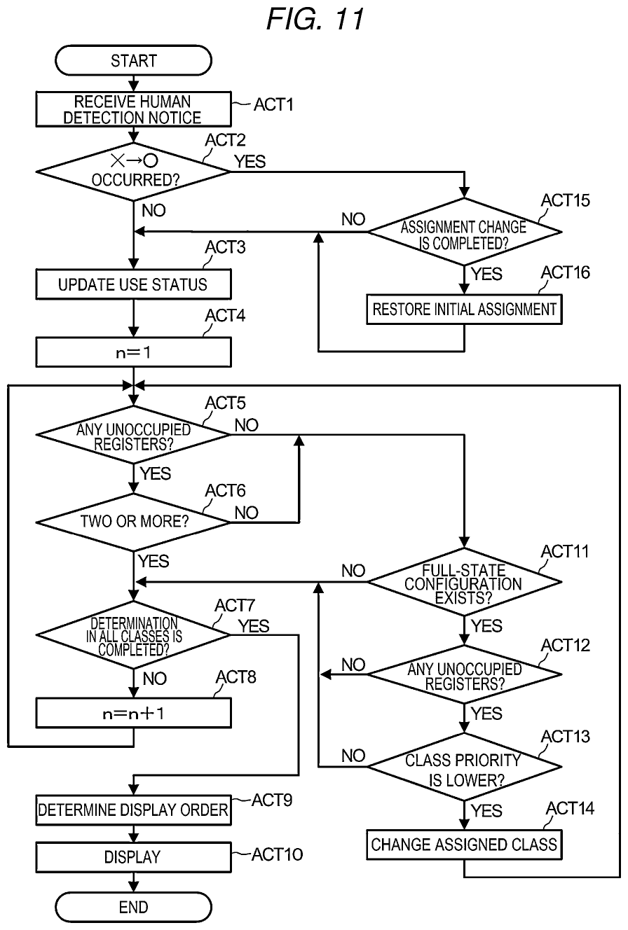

FIG. 11 is a flowchart representing a procedure of an essential part of information processing to be executed by the processor 11 of the store server SS. The processor 11 executes this processing at regular time intervals such as every several seconds based on the control program stored in the main memory 12 or the auxiliary storage device 13. Here, the description is presented citing when a plurality of unoccupied cash registers is introduced if possible as an example. It should be noted that the processing operation of the processor 11 makes the transition to ACT(x+1) after ACTx (x is a natural number) unless particularly described. Further, the procedure shown in FIG. 11 is illustrative only. The procedure is not particularly limited as long as substantially the same result can be obtained.

As ACT1, the use status detection unit 113 installed in the processor 11 receives the human detection notice transmitted from each of the checkout apparatuses, namely each of the self-service terminals SE and each of the cashless settlement self-service terminals CL, with the communication interface 15. It should be noted that out of the checkout apparatuses, the attendant terminal AT does not transmit the human detection notice as described above.

As ACT2, the use status detection unit 113 determines whether there is the checkout apparatus which makes the transition to the unoccupied state from the in-use state in the checkout apparatuses from which the human detection notice is not received, namely the unoccupied cash registers. Specifically, the use status detection unit 113 confirms the use status of that cash register number in the terminal status table 135 with respect to each of the unoccupied cash registers from which the human detection notice is received, and then determines that the transition from the in-use state to the unoccupied state is made when the use status represents the in-use state. When the use status is already set to the unoccupied state, the use status detection unit 113 determines that the transition from the in-use state to the unoccupied state is not made. When there is the checkout apparatus which made the transition from the in-use state to the unoccupied state, the use status detection unit 113 determines YES in ACT2, and then proceeds to ACT14. When there is no checkout apparatus which made the transition from the in-use state to the unoccupied state, the use status detection unit 113 determines NO in ACT2, and then proceeds to ACT3.

As ACT3, the use status detection unit 113 updates the use status in the terminal status table 135 based on the human detection notice thus received.

As ACT4, the assignment change unit 114 installed in the processor initializes a value of an internal counter n to “1.” The value of the internal counter n is used for designating the priority order of the class priority order in the guide configuration table 134.

As ACT5, the assignment change unit 114 determines whether there is an unoccupied cash register in the checkout apparatus class in the priority order represented by the value of the internal counter n. Specifically, the assignment change unit 114 obtains the checkout apparatus class in the priority order represented by the value of the internal counter n from the guide configuration table 134. Then, the assignment change unit 114 determines the presence or absence of an unoccupied cash register by determining whether there is the use status representing the unoccupied state in the use status of the cash register numbers to which the assigned class corresponding to that checkout apparatus class is assigned in the terminal status table 135. When there is no unoccupied cash register, the assignment change unit 114 determines NO in ACT5, and proceeds to ACT1l. When there is an unoccupied cash register, the assignment change unit 114 determines YES in ACT5, and proceeds to ACT6.

As ACT6, the assignment change unit 114 determines whether the number of the unoccupied cash registers is two or more. When there is just one unoccupied cash register, the assignment change unit 114 determines NO in ACT6, and proceeds to ACT1l. When there are two or more unoccupied cash registers, the assignment change unit 114 determines YES in ACT6, and proceeds to ACT7.

As ACT7, the assignment change unit 114 determines whether the status of the unoccupied cash register is determined with respect to all the classes in the guide configuration table 134. When the determination is completed in all the classes, the assignment change unit 114 determines YES in ACT7, and proceeds to ACT9. When the determination in all the classes is not completed, the assignment change unit 114 determines NO in ACT7, and proceeds to ACT8.

As ACT8, the assignment change unit 114 “increments” the value of the internal counter n. Subsequently, the assignment change unit 114 proceeds to ACT5.

In such a manner, the assignment change unit 114 proceeds with the determination of the unoccupied cash register in sequence from the checkout apparatus class higher in class priority order in the guide configuration table 134 until the determination of the status of the unoccupied cash register is completed with respect to all the classes in the guide configuration table 134.

As ACT9, the introduction unit 115 installed in the processor 11 determines a display order of the unoccupied cash registers to be displayed on the display devices DD. Specifically, the introduction unit 115 determines the display order in each of the checkout apparatus classes in accordance with the status of the unoccupied cash register at the present moment stored in the terminal status table 135, and the cash-register introduction priority order and the in-class cash-register-full configuration set in advance in the guide configuration table 134.

As ACT10, the introduction unit 115 makes the display devices DD perform the introductory display representing the unoccupied cash registers. Specifically, the introduction unit 115 generates display information representing the unoccupied cash registers arranged in the display order thus determined for each of the checkout apparatus classes. Then, the display information is transmitted to each of the display devices DD with the communication interface 15 in accordance with the display surface set in the guide configuration table 134.

In such a manner, in each of the classes of the checkout apparatus, when there are two or more unoccupied cash registers, such display information as to introduce first the unoccupied cash register higher in priority in accordance with the cash-register introduction priority order set in advance in the guide configuration table 134 is generated, and thus, it is possible to display the display information thus generated on the respective display devices DD installed so as to correspond respectively to the first and second entrance lanes AL1, AL2 as the introductory display.

Further, as ACT11, the assignment change unit 114 installed in the processor 11 determines whether there is a cash-register-full configuration. Specifically, the assignment change unit 114 determines whether the cash register number is set in the in-class cash-register-full configuration corresponding to the checkout apparatus class in the priority order represented by the value of the internal counter n in the guide configuration table 134. When the cash register number is set, the assignment change unit 114 can determine that there is the cash-register-full configuration. When there is no cash-register-full configuration, the assignment change unit 114 determines NO in ACT11, and proceeds to ACT7. When there is the cash-register-full configuration, the assignment change unit 114 determines YES in ACT11, and proceeds to ACT12.

As ACT12, the assignment change unit 114 determines whether any of the checkout apparatuses with the cash register numbers set in the in-class cash-register-full configuration is unoccupied. Specifically, the assignment change unit 114 determines whether the use status of that cash register number is in the unoccupied state in the terminal status table 135. When there is no unoccupied cash register, the assignment change unit 114 determines NO in ACT12, and proceeds to ACT7. When there is an unoccupied cash register, the assignment change unit 114 determines YES in ACT12, and proceeds to ACT13.

As ACT13, the assignment change unit 114 checks the guide configuration table 134 to determine whether the unoccupied cash register is the checkout apparatus which belongs to the class lower in class priority order. When the unoccupied cash register is not lower in class priority order, the assignment change unit 114 determines NO in ACT13, and proceeds to ACT7. When the unoccupied cash register is lower in class priority order, the assignment change unit 114 determines YES in ACT13, and proceeds to ACT14.

As ACT14, the assignment change unit 114 changes the assigned class of the cash register number of the unoccupied cash register in the terminal status table 135 to that checkout apparatus class in the priority order represented by the value of the internal counter n in accordance with the in-class cash-register-full configuration in the guide configuration table 134. Subsequently, the assignment change unit 114 proceeds to ACT5.

By executing the processing in ACT5 through ACT14 using the terminal status table 135 which is changed in such a manner, when there is no unoccupied cash register in the class of each of the checkout apparatuses, such display information as to guide to use an unoccupied cash register in the class lower in priority as an unoccupied cash register in that class is generated in accordance with the cash-register introduction priority order and the in-class cash-register-full configuration set in advance in the guide configuration table 134, and thus, it is possible to display the display information as the introductory display on the respective display devices DD installed so as to correspond respectively to the first and second entrance lanes AL1, AL2.

As ACT15, the assignment change unit 114 determines whether the change of the assigned class of the checkout apparatus in which the transition from the in-use state to the unoccupied state is made is completed. Specifically, the assignment change unit 114 confirms whether the assigned class of the cash register number of that checkout apparatus in the terminal status table 135 is the same as the configuration of the checkout apparatus class of the cash register number in the guide configuration table 134. Unless those coincide with each other, the assignment change unit 114 determines that the change in assigned class is completed. When the change in assigned class is not completed, the assignment change unit 114 determines NO in ACT15, and proceeds to ACT3. When the change in assigned class is completed, the assignment change unit 114 determines YES in ACT15, and proceeds to ACT16.

As ACT16, the assignment change unit 114 restores the assigned class thus changed to the initial assignment. Specifically, the assignment change unit 114 restores the assigned class of that checkout apparatus in the terminal status table 135 to the checkout apparatus class of the cash register number set in the guide configuration table 134. Subsequently, the assignment change unit 114 proceeds to ACT3.

A specific example of the unoccupied cash register introduction will hereinafter be described.

It is assumed that, for example, the use status of each of the cash registers becomes as in the terminal status table 135 shown in FIG. 5 in ACT3. This corresponds to the situation shown in FIG. 2. Here, first, in ACT5, presence or absence of an unoccupied cash register with respect to the cashless settlement self-service terminal CL having the highest class priority order is determined. In this case, since the cashless settling self-service terminal CL with the cash register number R6 exists as an unoccupied cash register, the process proceeds to ACT6 from ACT5. Further, since the number of the unoccupied cash registers is one in ACT6, the process proceeds to ACT11 from ACT6 as a result.

In ACT11, since the in-class cash-register-full configuration of the cashless settlement self-service terminal CL is set in the guide configuration table 134, the process proceeds to ACT12 from ACT11. In ACT12, since it can be determined that the cash register numbers R1, R4, and R5 out of the cash register numbers R1 through R5 set in the guide configuration table 134 are unoccupied from the terminal status table 135, the process proceeds to ACT13 from ACT12. Further, in ACT13, it is determined that those unoccupied cash registers are the self-service terminals SE in the priority order lower than that class priority order, and the process proceeds to ACT14 from ACT13. Therefore, in ACT14, assigned class change processing for assigning the self-service terminal SE with the cash register number R5 to the cashless settlement self-service is executed in accordance with the in-class cash-register-full configuration in the guide configuration table 134.

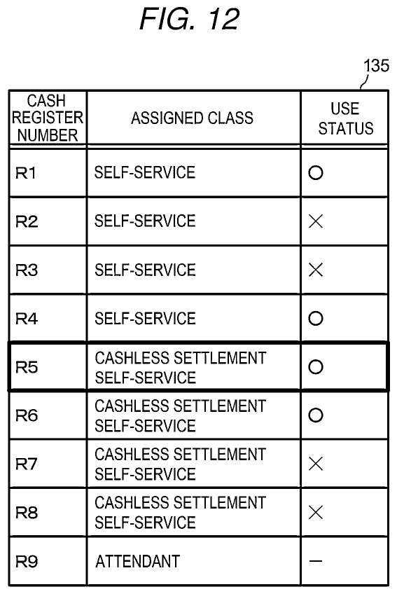

Thus, the storage content of the terminal status table 135 is rewritten from the state shown in FIG. 5 to what is shown in FIG. 12. FIG. 12 is a schematic diagram showing a principal data structure to be stored in the terminal status table 135. As shown in FIG. 12, the assigned class of the cash register number R5 is changed from the self-service to the cashless settlement self-service.

Subsequently, when the process proceeds to ACT6 from ACT5, since the checkout apparatuses with the cash register numbers R6, R5 are unoccupied cash registers, the process proceeds to ACT7 from ACT6 as a result on the grounds that the number of the unoccupied cash registers is two or more. Further, in ACT7, since there is the checkout apparatus class the determination of which is not completed, the process proceeds to ACT8, and since the counter value is “incremented by 1,” processing with respect to the self-service terminal SE in which the class priority order is set to “2” in the guide configuration table 134 is executed as a result.

In this case, in ACT5, the unoccupied cash register the assigned class of which is the self-service in the terminal status table 135 is determined as a result, and the cash register numbers R1 and R4 are determined as the unoccupied cash registers as shown in FIG. 12. The self-service terminal SE with the cash register number R5 is assumed to be used as a substitute for the cashless settlement self-service terminal CL, and is therefore not included in the unoccupied cash registers here. Since there are two unoccupied cash registers, the process proceeds to ACT7 from ACT5 via ACT6. In ACT7, since there is the checkout apparatus class the determination of which is not completed, the process proceeds to ACT8, and since the counter value is “incremented by 1,” processing with respect to the attendant terminal AT in which the class priority order is set to “3” in the guide configuration table 134 is executed as a result.

In this case, in ACT5, the unoccupied cash register the assigned class of which is the attendant in the terminal status table 135 is determined as a result, but the use status with respect to the attendant is exempt from the determination as shown in FIG. 12. Therefore, YES is unconditionally determined in ACT5 and ACT6, and the process proceeds to ACT7 as a result. Then, in ACT7, since there is no checkout apparatus class the determination of which is not completed, the process proceeds to ACT9.

In ACT9, regarding the cash register numbers R1, R4 corresponding to the unoccupied cash registers as the self-service terminals SE, the display order of the cash register number R1 and the cash register number R4 is determined in accordance with the cash-register introduction priority order in the guide configuration table 134. Further, regarding the cash register numbers R5, R6 corresponding to the unoccupied cash registers as the cashless settlement self-service terminal CL, the display order of the cash register number R6 and the cash register number R5 is determined in accordance with the cash-register introduction priority order and the in-class cash-register-full configuration in the guide configuration table 134. Then, in ACT10, the display information related to the unoccupied cash registers as the self-service terminals SE, and the display information related to the cashless settlement self-service terminals are generated, and the respective pieces of the display information are transmitted to the respective display devices DD in accordance with the display surface set in the guide configuration table 134.

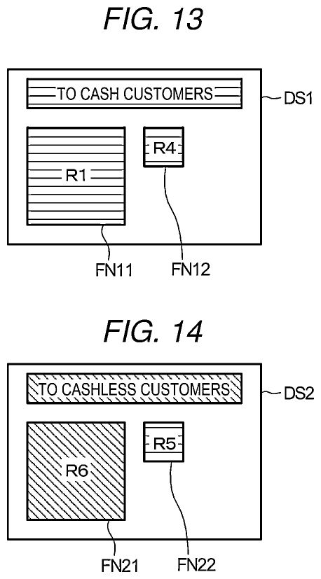

Thus, such introductory display as shown in FIG. 13 and FIG. 14 is performed. Here, FIG. 13 is a diagram showing a display example of the first display surface DS1 in the display device DD installed so as to correspond to the first entrance lane AL1 in which the cash payment shoppers SC stand for checkout. Further, FIG. 14 is a diagram showing a display example of the second display surface DS2 in the display device DD installed so as to correspond to the second entrance lane AL2 in which the cashless payment shoppers SC stand for checkout.

As shown in FIG. 13, on the first display surface DS1, two unoccupied cash register number displays FN11, FN12 as the first display information representing the checkout apparatuses available for the cash payment are displayed side by side. In this case, the cash register number display FN11 representing the cash register number R1 as the unoccupied cash register higher in priority order is displayed with a larger size, and the cash register number display FN12 representing the cash register number R4 as the unoccupied cash register lower in priority order is displayed with a smaller size at a lateral side thereof. As described above, the display device DD installed so as to correspond to the first entrance lane AL1 as the first standby lane for the cash payment as the first settlement method is an example of a first display device which has the first display surface DS1, and is disposed in the first standby lane for the first settlement method out of the first and second standby lanes which are separately disposed respectively for the first settlement method and the second settlement method, and in which the customers wait for settlement. The unoccupied cash register number displays FN11, FN12 are an example of the first introductory information representing the self-service terminals SE as the first checkout apparatuses which are available for the cash payment as the first settlement method.

Further, as shown in FIG. 14, on the second display surface DS2, two unoccupied cash register number displays FN21, FN22 as the second display information representing the checkout apparatuses available for the cashless payment are displayed side by side. In this case, the cash register number display FN21 representing the cash register number R6 as the unoccupied cash register higher in priority order is displayed with a larger size, and the cash register number display FN22 representing the cash register number R5 as the unoccupied cash register lower in priority order is displayed with a smaller size at a lateral side thereof. As described above, the display device DD installed so as to correspond to the second entrance lane AL2 as the second standby lane for the cashless payment as the second settlement method is an example of a second display device which has the second display surface DS2, and is disposed on the second standby lane for the second settlement method. The unoccupied cash register number displays FN21, FN22 are an example of the second introductory information representing the self-service terminals SE and the cashless settlement self-service terminals CL as the second checkout apparatuses which are available for the cashless payment as the second settlement method.

It should be noted that it is assumed that the procedure of the information processing shown in FIG. 11 is executed at regular time intervals, and the regular time intervals can be set based on the time necessary for the move of the shopper SC. The time corresponds to the time necessary for the shopper SC to move from an entrance for the cash payment shopper and an entrance for the cashless payment shopper SC of the payment place CE which are exits of the first entrance lane AL1 and the second entrance lane AL2 to the farthest checkout apparatus of the checkout apparatuses which has a possibility of being displayed as the unoccupied cash register. In the example of FIG. 2, when it is assumed that it takes 10 seconds at typical moving speed for the shopper SC who stands in the second entrance lane AL2 to move to the farthest cash register number R2, the procedure of the information processing shown in FIG. 11 is executed every 10 seconds. Thus, the introductory display on the first display surface DS1 and the second display surface DS2 based on new unoccupied cash register detection is updated every 10 seconds.

Further, the shopper SC who looks at the introduction of the unoccupied cash register on the first display surface DS1 or the second display surface DS2 moves from the first entrance lane AL1 or the second entrance lane AL2 to the unoccupied cash register with the cash register number R1 or R6 displayed with the larger size. When continuing such an introductory display as shown in FIG. 13 or FIG. 14 during this move, the next shopper SC starts moving to the same cash register. Therefore, it is possible to update the display in response to the start of the move of the shopper SC to the unoccupied cash register with the cash register number R1 or R6 in such a manner that the unoccupied cash register number display FN11 or FN21 displayed with the larger size is deleted and the unoccupied cash register number display FN12 or FN22 displayed with the smaller size is displayed with the larger size. The start of the move of the shopper SC may be determined by, for example, detecting passage of the shopper SC with sensors or the like disposed at the entrance for the cash payment shoppers and the entrance for the cashless payment shoppers of the payment place CE as the exits of the first entrance lane AL1 and the second entrance lane AL2. Further, when the new shopper SC further starts the move based on the introductory display thus updated, the display of the unoccupied cash register number display FN12 or FN22 is also deleted, and then it is displayed that the detection of an unoccupied cash register is in progress.

In the checkout apparatus with the cash register number R5 which is used as a substitute for the cashless settlement self-service terminal CL despite the self-service terminal SE, when the checkout by the shopper SC is completed, then the shopper SC moves away from that checkout apparatus, and thus, that checkout apparatus turns to an unoccupied cash register, this fact is detected in ACT2. Thus, the process proceeds to ACT15 from ACT2, it is determined in ACT15 that the assignment is changed, and in ACT16, the checkout apparatus with the cash register number R5 becomes available for the self-service SE which is the initial assignment. Obviously, depending on the status of unoccupied cash registers at that moment, there is a possibility that the checkout apparatus with the cash register number R5 is used again as a substitute for the cashless settlement self-service terminal CL in a processing procedure which proceeds to ACT3 from ACT16.

As described above, according to the guide system relate to the first embodiment, in the checkout system in which the plurality of self-service terminals SE as the first checkout apparatuses which can accept the settlement with the cash payment as the first settlement method and the cashless payment as the second settlement method and one or more cashless settlement self-service terminal CL as the second checkout apparatus which can accept the settlement with the cashless payment are installed in the payment place CE, the display device DD as the introduction device which introduces the available checkout apparatus to, for example, the customer, and the store server SS as the management apparatus which determines the self-service terminal SE available for the cash payment and the self-service terminal SE and the cashless settlement self-service terminal CL which are available for the cashless payment based on the unoccupied status of each of the self-service terminal SE and the cashless settlement self-service terminal CL and the priority order set in advance and stored in the guide configuration table 134, and which makes the display device DD introduce the result are provided.

Therefore, according to the guide system related to the first embodiment, since it is possible to introduce an appropriate checkout apparatus as the unoccupied cash register in accordance with the unoccupied state of each of the checkout apparatuses and the priority order, it becomes possible to introduce the appropriate checkout apparatuses to the customers who use the payment place CE in which a plurality of checkout apparatuses different in class in which the checkout apparatus can achieve a settlement.

Further, the priority order set in advance includes the class priority order as the priority order of the settlement method, and the store server SS assigns the checkout apparatus which belongs to the settlement method in the lower priority order to the settlement method in the higher priority order when the checkout apparatus which belongs to the settlement method in the higher priority order is full.

Therefore, according to the guide system in the first embodiment, when there is no unoccupied cash register which belongs to a certain settlement method, it becomes possible to introduce the checkout apparatus which belongs to a settlement method lower in priority order than that settlement method as the unoccupied cash register of that settlement method.

Here, the priority order set in advance further includes the in-class cash-register-full configuration which is a priority order when assigning the checkout apparatus which belongs to the settlement method in a lower priority order to a settlement method in a higher priority order.

Therefore, according to the guide system related to the first embodiment, it becomes possible to determine in advance which one of the checkout apparatuses should be used when introducing the checkout apparatus which belongs to the settlement method in the lower priority order as an unoccupied cash register of that settlement method.

Further, the guide system in the first embodiment includes the first and second display surfaces DS1, DS2 as the introduction device, and the store server SS makes the first display surface DS1 display, for example, the unoccupied cash register number displays FN11, FN12 as the first display information representing the checkout apparatuses which are available for the cash payment arranged side by side in accordance with the priority order set in advance, and makes the second display surface DS2 display, for example, the unoccupied cash register number displays FN21, FN22 as the second display information representing the checkout apparatuses which are available for the cashless payment arranged side by side in accordance with the priority order set in advance.

Therefore, according to the guide system related to the first embodiment, it is possible to introduce the respective unoccupied cash registers separately for the respective settlement methods.

Here, the guide system includes the first display device DD having the first display surface DS1 and the second display device DD having the second display surface DS2 as the introduction device, the first display device DD is disposed in the first entrance lane AL1 which is the first standby lane for cash payment out of the standby lanes which are separately provided respectively for the cash payment and cashless payment, and in which the shoppers SC wait for settlement, and the second display device DD is disposed in the second entrance lane AL2 as the second standby lane for the cashless payment.

Therefore, according to the guide system related to the first embodiment, in each of the entrance lanes separately provided to the respective settlement methods, it is possible to display the unoccupied cash registers used in that settlement method.

Further, the store server SS as the management device according to the first embodiment is provided with the use status detection unit 113 as the detection unit for detecting the unoccupied status of each of the self-service terminals SE as the plurality of first checkout apparatuses which can accept the settlement with the cash payment as the first settlement method and the cashless payment as the second settlement method, and the cashless settlement self-service terminals CL as one or more second checkout apparatuses which can accept the cashless payment, the assignment change unit 114 as the assignment unit which determines the self-service terminal SE available for the cash payment and the self-service terminal SE and the cashless settlement self-service terminal CL which are available for the cashless payment based on the unoccupied status of each of self-service terminal SE and the cashless settlement self-service terminal CL detected by the use status detection unit 113, and the priority order set in advance and stored in the guide configuration table 134, and the introduction unit 115 as the output unit which outputs the first introductory information representing the self-service terminal SE available for the cash payment, and the second introductory information representing the self-service terminal SE and the cashless settlement self-service terminal CL which are available for the cashless payment determined by the assignment change unit 114 to the display device DD as the external device.

Therefore, according to the store server SS in the first embodiment, since it is possible to introduce an appropriate checkout apparatus as the unoccupied cash register in accordance with the unoccupied state of each of the checkout apparatuses and the priority order, it becomes possible to introduce the appropriate checkout apparatuses to the customers who use the payment place CE in which a plurality of checkout apparatuses different in class in which the checkout apparatus can achieve a settlement.

### Second Embodiment

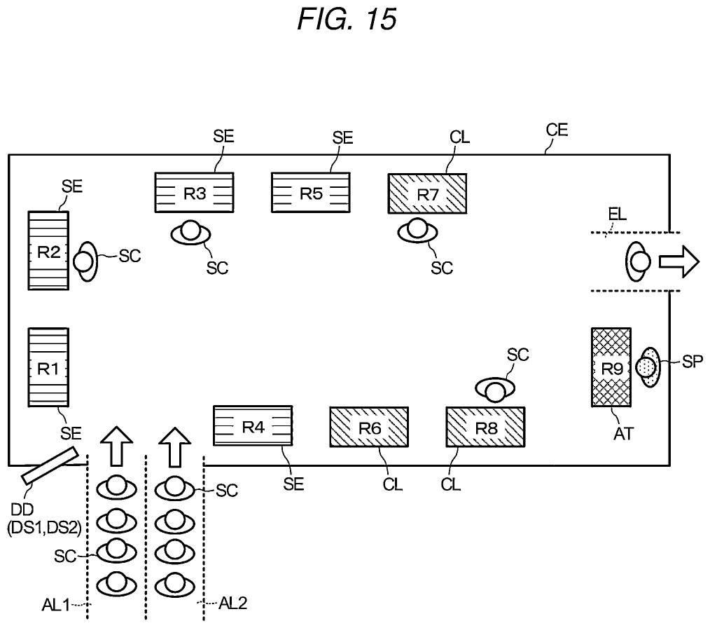

FIG. 15 is a schematic diagram showing an example of the payment place CE to which a guide system according to a second embodiment is applied. In the first embodiment, the entrance for the cash payment shoppers and the entrance for the cashless payment shoppers are set separately from each other, and the entrance lanes are disposed in the respective entrances. The present second embodiment is an example in which two entrance lanes, namely the first and second entrance lanes AL1, AL2, are disposed in a single entrance.

In such an installation layout in the payment place CE, it is possible to install totally two display devices DD respectively for the first and second entrance lanes AL1, AL2 independently of each other. Further, as shown in FIG. 15, it is possible to adopt a single display device DD alone. In this case, the single display device DD is provided with the first and second display surfaces DS1, DS2.

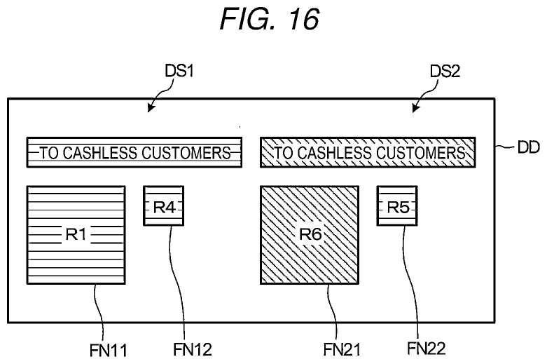

FIG. 16 is a diagram showing a display example of the first and second display surfaces DS1, DS2 in this display device DD. As shown in FIG. 16, the display screen of the display device DD is divided, and the two display surfaces DS1, DS2 are displayed side by side.

As described above, even when adopting the display method in which the display screen of the display device DD is divided into a plurality of display parts, it is possible for the management device configured as the guide system and the store server SS to obtain substantially the same advantages as those of the first embodiment.

The embodiments of the guide system and the management device are hereinabove described, but such embodiments are not limited thereto.

For example, in the embodiments, the description is presented citing the self-service type checkout system in which the shopper executes the article registration as an example, but it is possible to adopt a checkout system in which the sales clerk performs the article registration, and the shopper performs the checkout processing on the transaction data of the purchased article on which the sales clerk performed the article registration. In other words, the checkout apparatus disposed in the payment place CE may be a semi-self-service type checkout apparatus in which the sales clerk performs the article registration and the shopper performs the checkout. Alternatively, it is assumed that the sales clerk performs the article registration with a registration device in a registration place provided separately from the payment place CE, and it is possible for the checkout apparatus disposed in the payment place CE to be the checkout apparatus for accepting only the checkout of the shopper based on the transaction data.

Further, it is assumed that a single display device DD is installed in each of the entrance lanes in the first embodiment, and a single display device DD is installed collectively in the two lanes in the second embodiment, but it is possible to install a plurality of display devices DD in each of the entrance lanes.

Further, it is possible to arrange that a sales clerk is assigned to the entrance of the payment place CE, and the sales clerk orally introduces the checkout apparatus to the shoppers. In this case, it is sufficient for the display device DD to be installed at a position where the unoccupied cash register (an occupied apparatus) can be introduced to the clerk instead of the shopper.

Further, in the first embodiment, only the introduction of the unoccupied cash register corresponding to that settlement method is displayed on the display device DD for each of the entrance lanes, but it is also possible to additionally perform the introduction of the unoccupied cash register corresponding to other settlement methods as in the second embodiment. This makes it possible for the shoppers SC who stand in the entrance lane to confirm the fact that the checkout apparatus of other settlement method is unoccupied, and then change the settlement method to use the unoccupied cash register.

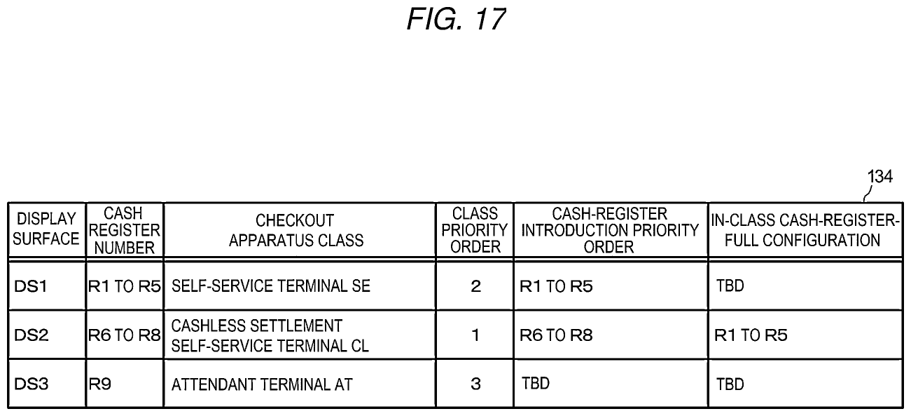

Further, the priority order set to each of the configuration items of the cash-register introduction priority order and the in-class cash-register-full configuration in the guide configuration table 134 is not necessary required for the administrator to designate the order. As shown in FIG. 17, it is possible to arrange that, for example, the administrator only selects whether to set the cash register number or leave it unset, and the processor 11 of the store server SS randomly determines which one of the unoccupied cash registers is selected. Thus, it is possible to prevent the use frequencies of the respective checkout apparatuses from becoming uneven. This is helpful in reducing the failure occurrence risk in particular in a mechanical movable part in the automatic change dispenser 27, the card reader 28, and so on.

Alternatively, it is also possible to arrange that the processor 11 randomly determines the priority order from the cash register numbers thus set. In this case, it is possible for the processor 11 to periodically change the order set randomly as described above. Since the higher the priority order of the checkout apparatus is the higher the chance of use of that checkout apparatus is, by periodically changing the priority order as described above, it is possible to prevent the use frequencies of the respective checkout apparatuses from being uneven.

Further, in the first and second embodiments, it is assumed that the store server SS determines the use statuses of the self-service terminals SE and the cashless settlement terminals CL based on the presence or absence of the human detection notice transmitted from those terminals, but it is possible to determine the use status using other information in stead thereof, or in addition thereto. For example, since the attendant terminal AT collects the statuses representing the operation status and the error status in each of the self-service terminals SE and the cashless settlement self-service terminals CL, the store server SS can know the use status of each of the checkout apparatuses by obtaining the status information of each of the checkout apparatuses from the attendant terminal AT.

In addition, although some embodiments of the present disclosure are described, these embodiments are illustrative only, and it is not intended to limit the scope of the present disclosure. These novel embodiments can be implemented with other various aspects, and a variety of omissions, replacements, and modifications can be made within the scope or the spirit of the present disclosure. These embodiments and modifications thereof are included in the scope of the present disclosure, and at the same time, included in the present disclosure set forth in the appended claims, and the equivalents thereof.

What is claimed is:

1. A guide system, comprising:
a plurality of first checkout apparatuses configured to accept settlements with a first settlement method and a second settlement method;
at least one second checkout apparatus configured to accept a settlement with the second settlement method;
an introduction device configured to introduce an available checkout apparatus; and
a management device configured to determine availability of the first checkout apparatus for the first settlement method and availability of the first and second checkout apparatuses for the second settlement method based on an unoccupied status of each of the first and second checkout apparatuses and a priority order set in advance, and to make the introduction device introduce the checkout apparatuses determined available.

2. The guide system according to claim 1, wherein
the priority order set in advance includes a priority order of the settlement method, and
the management device is configured to assign the checkout apparatus which belongs to the settlement method in a lower priority order to the settlement method in a higher priority order when the checkout apparatus which belongs to the settlement method in the higher priority order is full.

3. The guide system according to claim 2, wherein
the priority order set in advance further includes a priority order when assigning the checkout apparatus which belongs to the settlement method in the lower priority order to the settlement method in the higher priority order.

4. The guide system according to claim 1, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

5. The guide system according to claim 2, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

6. The guide system according to claim 3, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

7. The guide system according to claim 4, wherein
the introduction device includes a first display device having the first display surface and a second display device having the second display surface,
the first display device is provided to a first standby lane for the first settlement method out of the first standby lane and a second standby lane which are separately disposed respectively for the first and second settlement methods, and in which customers wait for the settlement, and
the second display device is provided to the second standby lane for the second settlement method.

8. A management device, comprising:
a detector configured to detect an unoccupied status of each of a plurality of first checkout apparatuses configured to accept a settlement with a first settlement method and a second settlement method, and at least one second checkout apparatus configured to accept a settlement with the second settlement method;
an assignment component configured to determine availability of the first checkout apparatuses for the first settlement method and availability of the first and second checkout apparatuses for the second settlement method based on an unoccupied status of each of the first and second checkout apparatuses detected by the detector, and a priority order set in advance; and
an output component configured to output first introductory information representing availability of the first checkout apparatus for the first settlement method determined by the assignment component, and second introductory information representing availability of the first and second checkout apparatuses for the second settlement method determined by the assignment component to an external device.

9. The management device according to claim 8, wherein
the priority order set in advance includes a priority order of the settlement method, and
the management device is configured to assign the checkout apparatus which belongs to the settlement method in a lower priority order to the settlement method in a higher priority order when the checkout apparatus which belongs to the settlement method in the higher priority order is full.

10. The management device according to claim 9, wherein
the priority order set in advance further includes a priority order when assigning the checkout apparatus which belongs to the settlement method in the lower priority order to the settlement method in the higher priority order.

11. The management device according to claim 8, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

12. The management device according to claim 9, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

13. The management device according to claim 10, wherein
the introduction device includes first and second display surfaces, and
the management device is configured to
make the first display surface display first display information representing the checkout apparatus available for the first settlement method so as to be arranged in accordance with the priority order set in advance, and
make the second display surface display second display information representing the checkout apparatus available for the second settlement method so as to be arranged in accordance with the priority order set in advance.

14. The management device according to claim 11, wherein
the introduction device includes a first display device having the first display surface and a second display device having the second display surface,
the first display device is provided to a first standby lane for the first settlement method out of the first standby lane and a second standby lane which are separately disposed respectively for the first and second settlement methods, and in which customers wait for the settlement, and
the second display device is provided to the second standby lane for the second settlement method.

15. A method for controlling a management device which includes a processor and a memory, which is connected to a plurality of first checkout apparatuses configured to accept a settlement with a first settlement method and a second settlement method, at least one second checkout apparatus configured to accept a settlement with the second settlement method, and an introduction device configured to introduce an available checkout apparatus via a network, the method comprising:
detecting an unoccupied status of each of the plurality of first checkout apparatuses and the at least one second checkout apparatus;
determining availability of the first checkout apparatuses for the first settlement method and availability of the first and second checkout apparatuses for the second settlement method based on an unoccupied status of each of the first and second checkout apparatuses detected in the detecting the unoccupied status, and a priority order stored in advance in the memory; and
outputting first introductory information representing the first checkout apparatus available for the first settlement method determined in the determining availability of the first checkout apparatuses for the first settlement method and availability of the first and second checkout apparatuses for the second settlement method, and second introductory information representing the first and second checkout apparatuses available for the second settlement method determined in the determining availability of the first checkout apparatuses for the first settlement method and availability of the first and second checkout apparatuses for the second settlement method, to the introduction device.

16. The method according to claim 15, wherein
the priority order set in advance includes a priority order of the settlement method,
further comprising:
assigning the checkout apparatus which belongs to the settlement method in a lower priority order to the settlement method in a higher priority order when the checkout apparatus which belongs to the settlement method in the higher priority order is full.

17. The method according to claim 16, further comprising:
the priority order set in advance further includes a priority order when assigning the checkout apparatus which belongs to the settlement method in the lower priority order to the settlement method in the higher priority order.

18. The method according to claim 15, wherein
the introduction device includes first and second display surfaces, and
further comprising:
making the first display surface display first display information representing the checkout apparatus available for the first settlement method so as to be arranged in accordance with the priority order set in advance, and
making the second display surface display second display information representing the checkout apparatus available for the second settlement method so as to be arranged in accordance with the priority order set in advance.

19. The method according to claim 16, wherein
the introduction device includes first and second display surfaces, and
further comprising:
making the first display surface display first display information representing the checkout apparatus available for the first settlement method so as to be arranged in accordance with the priority order set in advance, and
making the second display surface display second display information representing the checkout apparatus available for the second settlement method so as to be arranged in accordance with the priority order set in advance.

20. The method according to claim 17, wherein
the introduction device includes first and second display surfaces, and
further comprising:
making the first display surface display first display information representing the checkout apparatus available for the first settlement method so as to be arranged in accordance with the priority order set in advance, and
making the second display surface display second display information representing the checkout apparatus available for the second settlement method so as to be arranged in accordance with the priority order set in advance.
